(19) United States
(12) Patent Application Publication
(10) Pub. No.: US 2025/0334166 A1
(43) Pub. Date: Oct. 30, 2025

(54) 3D-Printed Vibration Damper with Multilayer Structure for Rotary Motor Shafts

(71) Applicant: Aarav Kalpesh Upadhyay, Ocean, NJ (US)

(72) Inventor: Aarav Kalpesh Upadhyay, Ocean, NJ (US)

(21) Appl. No.: 19/253,957

(22) Filed: Jun. 29, 2025

Related U.S. Application Data
(60) Provisional application No. 63/666,165, filed on Jun. 29, 2024.

(51) Int. Cl. F16F 15/04; B33Y 80/00

(52) U.S. Cl. CPC F16F 15/04; B33Y 80/00

(57) ABSTRACT

A 3D-printed vibration damper for rotary motor shafts comprises a rigid PLA outer ring, a concentric dual-material PLA/TPU inner ring with a 0.1-0.5 mm annular gap, and four coil springs arranged at 90° intervals. The outer ring mounts to the motor, while the inner ring interfaces with the shaft. Shaft oscillations above 0.3 mm engage the elastomeric sheath, compressing the springs and dissipating energy via internal friction and hysteresis. Under a 10% rotor imbalance at 3,000 RPM, the system reduces vibration amplitude by over 40%. The design is tunable through filament choice, infill pattern, spring parameters, and print settings to optimize damping performance for varying operational conditions.

### Cross-Reference to Related Applications

This application claims priority to U.S. Provisional Patent Application No. 63/666,165, filed Jun. 29, 2024, the entire disclosure of which is incorporated herein by reference.

### STATEMENT REGARDING FEDERALLY SPONSORED RESEARCH

Not applicable.

### BACKGROUND OF THE INVENTION

### Field of the Invention

The present invention relates to vibration mitigation in rotating mechanical systems, particularly targeting torsional oscillations in electric motors operating at frequencies between 50 Hz and 500 Hz, such as those found in electric vehicles, industrial fans, and robotic actuators.

### DESCRIPTION OF THE RELATED ART

Electric motor shafts often experience vibrational amplitudes ranging from 0.1 mm to 1.0 mm due to rotor imbalance, misalignment, or drive ripple. These vibrations can accelerate bearing fatigue, generate audible noise above 60 dB, and reduce drivetrain efficiency by up to 10%. Existing damping solutions, such as machined mass-spring assemblies or molded elastomeric isolators, require specialized tooling, are limited to fixed geometries, and cannot be easily tailored to specific shaft sizes or operational frequencies. Prior art includes:
U.S. Pat. No. 7,438,165 B2¹: Dual-mass electromagnetic damper lacking 3D-printed components.
U.S. Pat. No. 11,028,897 B2² (KR 101263246 B2) 3: Machined hub-ring assembly with metal springs, lacking tunable printed structures.
U.S. Pat. No. 4,488,629 A⁴ and U.S. Pat. No. 11,387,705 B2⁵: Friction-based and tuned-mass dampers without additive manufacturing flexibility.

A need exists for a low-cost, rapidly customizable damper that integrates 3D-printed multilayer rings and discrete spring arrays to attenuate vibrations effectively across a wide frequency range in compact motor-driven systems.

### SUMMARY OF THE INVENTION

An apparatus for damping vibrations in rotary motor shafts includes an outer annular ring made from a rigid thermoplastic using fused deposition modeling. The outer body surrounds an inner concentric ring composed of a rigid core encapsulated by an elastomeric sheath, forming an annular gap between 0.1 and 0.5 millimeters. Four discrete coil springs are uniformly positioned at 90-degree intervals between the outer and inner structures. These springs are affixed to the interior of the outer ring and oriented to embed into the elastomeric sheath during compression. When shaft vibrations exceed 0.3 millimeters in amplitude, the shaft first contacts the elastomeric sheath, which in turn compresses the coil springs. This interaction dissipates vibrational energy through both mechanical spring friction and hysteresis within the elastomeric material. The damper achieves a reduction in vibration amplitude of at least 40% under test conditions simulating a 10% mass imbalance at 3000 revolutions per minute. The configuration is tunable through print parameters, filament selection, and spring characteristics.

### BRIEF DESCRIPTION OF THE DRAWINGS

FIG. 1: Exploded view of damper components.

FIG. 2: Isometric view of the assembled vibration damper.

FIG. 3: Isometric view of the bottom of the assembled vibration damper.

FIG. 4: Isometric view of the damper mounted on motor flange.

FIG. 5: Cross-section of damper mounted on motor flange.

### DETAILED DESCRIPTION OF THE INVENTION

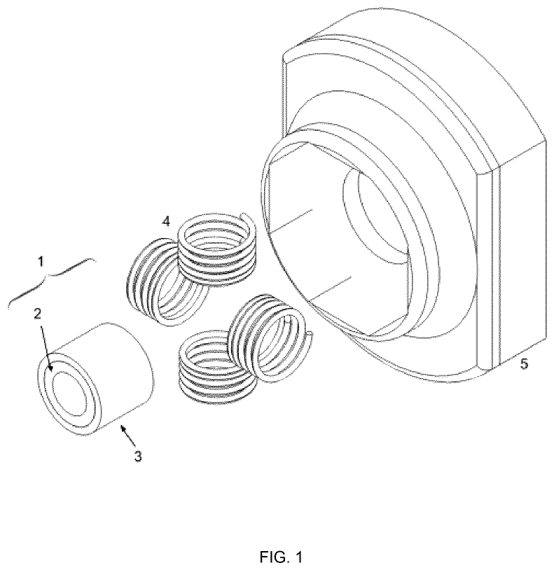

Referring to FIG. 1, the vibration damper assembly includes an outer annular ring (5) fabricated via fused deposition modeling (FDM) from a rigid thermoplastic material such as polylactic acid (PLA). The outer ring (5) is designed to mount onto the motor flange, providing a stable structure to hold the damping components in place.

The inner annular body (1), shown in FIG. 1, is concentric with the outer ring (5) and consists of a rigid PLA core (2) encapsulated by an elastomeric sheath (3) made of thermoplastic polyurethane (TPU) with a Shore hardness between 90 A and 95 A. The inner ring (1) is manufactured by dual extrusion 3D printing to achieve a multilayer structure, creating an annular gap ranging from 0.1 mm to 0.5 mm between itself and the outer ring (5).

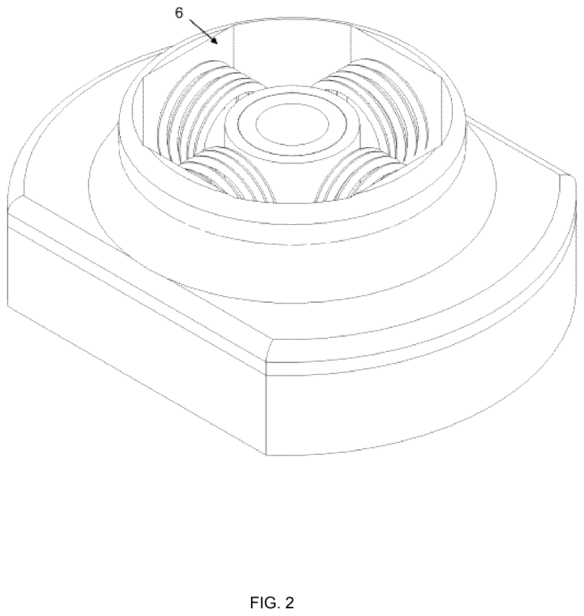

Between the outer ring (5) and the inner ring (1) are four discrete coil springs (4) arranged at uniform 90-degree intervals, as illustrated in FIG. 1. The coil springs (4) are adhesively affixed to the inner surface of the outer ring (5). The adhesion secures the springs firmly, allowing their coils to partially embed into the TPU sheath (3) of the inner ring (1), thereby enhancing mechanical engagement and energy dissipation during compression, as shown in FIG. 2.

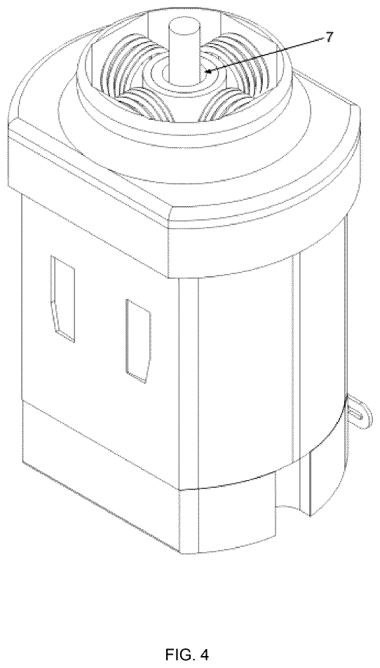

In operation, the motor shaft is free to rotate within the annular gap between the outer ring (5) and the PLA core (2) of the inner ring (1), maintaining clearance when shaft oscillations remain below a threshold amplitude of 0.3 mm, as depicted in FIG. 4. When oscillations exceed this threshold, the shaft contacts the rigid PLA core (2), transferring vibrational forces to the elastomeric TPU sheath (3). This contact causes compression of the coil springs (4) between the outer ring (5) and inner ring (1), thereby dissipating vibrational energy through friction within the springs and hysteresis losses in the TPU material.

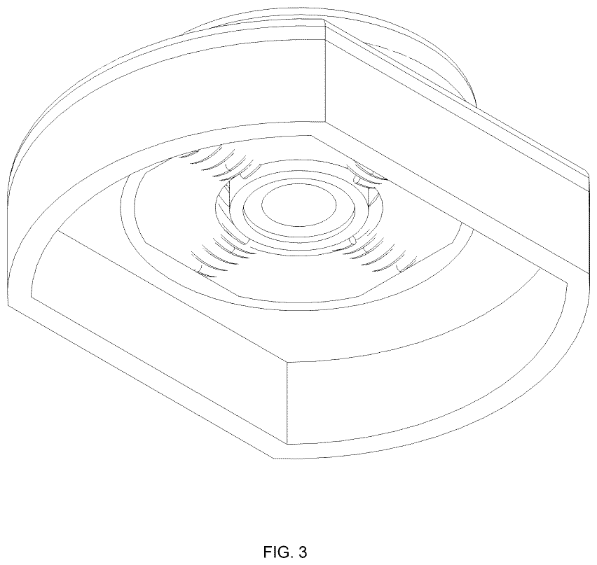

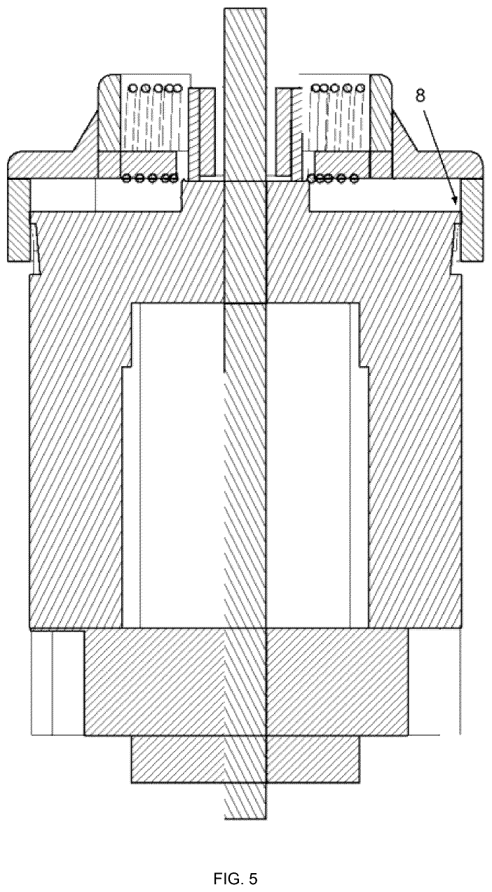

FIG. 3 presents a bottom isometric view of the assembled damper, emphasizing the relative positions of the inner ring (1), outer ring (5), and coil springs (4). FIG. 5 illustrates a cross-sectional view of the damper installed on a motor flange, showing the transition fit (8) that secures the outer ring (5) to the motor housing and the space (7) between the shaft and the PLA core (2).

Manufacturing parameters include printing the PLA outer ring (5) at temperatures between 210° C. and 230° C. with 100% infill, using a 0.4 mm nozzle and 0.2 mm layer height. The dual-material inner ring (1) is printed with PLA at 210-230° C. and TPU at 220-240° C., employing similar nozzle sizes and print layer heights. Print speeds vary from 30 mm/s to 60 mm/s, and infill patterns such as grid, gyroid, or honeycomb may be selected to optimize stiffness and damping characteristics.

The coil springs (4) are manufactured from steel and have free lengths ranging from 2.0 mm to 5.0 mm. These springs can be selected and tuned to match the operational frequency and damping requirements of specific motor applications.

Testing of the assembled damper has demonstrated a reduction in vibration amplitude of at least 40% under simulated rotor mass imbalances of 10% at rotational speeds of 3000 revolutions per minute (RPM), covering frequencies in the range of 50 Hz to 500 Hz.

### Preferred Embodiments

Filament extrusion temperatures range from 210-230° C. for PLA and 220-240° C. for TPU. Printing is performed with a 0.2 mm layer height, print speeds between 30-60 mm/s, and infill densities from 20% to 100%, using patterns such as grid, gyroid, or honeycomb.

### Alternative Embodiments

High-temperature polymers such as PEEK or PEKK may be used to enhance thermal resistance. The number and arrangement of coil springs can vary from two to six to suit specific damping requirements. The outer ring may be secured to the motor housing flange by mechanical fasteners including set screws or clamps.

A number of implementations have been described. Nevertheless, it will be understood that additional modifications may be made without departing from the spirit and scope of the inventive concepts described herein, and, accordingly, other embodiments are within the scope of the following claims.

1. An apparatus for damping vibrations in a rotary motor assembly, the apparatus comprising:
a) an outer annular body, additively manufactured from a rigid thermoplastic via fused deposition modeling (FDM), wherein the outer annular body is configured to mount onto a motor housing flange;
b) an inner concentric annular body positioned within the outer annular body and comprising a rigid core and an elastomeric sheath encapsulating the rigid core;
c) an annular gap between the outer annular body and the inner concentric annular body, the annular gap having a width ranging from 0.1 millimeters to 0.5 millimeters, permitting free rotation of a motor shaft when shaft oscillations are below a threshold amplitude; and
d) a plurality of discrete coil springs affixed to the inner surface of the outer annular body at uniform angular intervals, the coil springs positioned to engage the elastomeric sheath of the inner concentric annular body when shaft oscillations exceed the threshold amplitude, whereby compressive forces on the coil springs dissipate vibrational energy through spring friction and hysteresis within the elastomeric sheath.

2. The apparatus of claim 1, wherein the outer annular body is printed from polylactic acid (PLA).

3. The apparatus of claim 1, wherein the inner concentric annular body comprises a rigid core printed from PLA and an elastomeric sheath printed from thermoplastic polyurethane (TPU) having a Shore hardness between 90 A and 95 A.

4. The apparatus of claim 1, wherein each coil spring has a free length between 2.0 millimeters and 5.0 millimeters.

5. The apparatus of claim 1, wherein the plurality of coil springs comprises four springs positioned at 90-degree intervals.

6. The apparatus of claim 1, wherein the coil springs are permanently affixed to the inner surface of the outer annular body via adhesive bonding or mechanical retention features.

7. The apparatus of claim 1, wherein the apparatus reduces vibration amplitude by at least 40% when subjected to a rotor mass imbalance of 10% at 3000 revolutions per minute, as measured by an accelerometer.

8. The apparatus of claim 1, wherein the fused deposition modeling process includes an infill density ranging from 20% to 100%, with infill patterns selected from the group consisting of grid, gyroid, and honeycomb.

9. The apparatus of claim 1, further comprising mechanical fasteners selected from the group consisting of set screws and clamps, securing the outer annular body to the motor housing flange.

10. The apparatus of claim 1, wherein the rigid thermoplastic of the outer annular body is selected from the group consisting of polylactic acid (PLA), polyether ether ketone (PEEK), and polyether ketone ketone (PEKK), to provide enhanced thermal resistance.

11. The apparatus of claim 1, wherein the number of coil springs ranges from two to six and the springs are arranged to optimize damping performance for varying shaft sizes and vibrational frequencies.
